(19) United States
(12) Patent Application Publication
(10) Pub. No.: US 2015/0261867 A1
(43) Pub. Date: Sep. 17, 2015

(54) METHOD AND SYSTEM OF MANAGING CUES FOR CONVERSATION ENGAGEMENT

(71) Applicants: ROHIT SINGAL, Palo Alto, CA (US); Robert Brett Clanton, Dunwoody, GA (US); Piotr Gajos, San Francisco, CA (US); Pranav Shah, Fremont, CA (US); Ajit Vasudevan, San Francisco, CA (US); Thomas Angistalis, Proti, CA (US); Lukasz Sarnacki, Pruszkow (PL)

(72) Inventors: ROHIT SINGAL, Palo Alto, CA (US); Robert Brett Clanton, Dunwoody, GA (US); Piotr Gajos, San Francisco, CA (US); Pranav Shah, Fremont, CA (US); Ajit Vasudevan, San Francisco, CA (US); Thomas Angistalis, Proti, CA (US); Lukasz Sarnacki, Pruszkow (PL)

(21) Appl. No.: 14/208,569

(22) Filed: Mar. 13, 2014

(51) Int. Cl. G06F 17/30

(52) U.S. Cl. CPC G06F 17/30867; G06F 17/3043

(57) ABSTRACT

In one exemplary aspect, a method of managing cues for conversation management includes generating, with at least one processor, a first user-interest profile. A list of first-user topics from the first user-interest profile is created. An electronic conversation between the first user and a second user is obtained. A list of already discussed topics in the electronic conversation is generated. The list of already discussed topics is filtered from the list of first-user topics to create a suggested topics cue. At least one suggested topic is provided to the second user via a computer display.

### CROSS-REFERENCE TO RELATED APPLICATIONS

This application claims priority to U.S. provisional patent application No. 61/788,342, titled METHOD AND SYSTEM OF MANAGING CUES FOR CONVERSATION ENGAGEMENT, and filed on Mar. 15, 2013. This application is incorporated herein by reference.

### BACKGROUND

This application relates generally to human-computer interaction, and more specifically to a system, article of manufacture and method of managing cues for conversation management.

### BRIEF SUMMARY OF THE INVENTION

In one aspect, a method of managing cues for conversation management includes generating, with at least one processor, a first user-interest profile. A list of first-user topics from the first user-interest profile is created. An electronic conversation between the first user and a second user is obtained. A list of already discussed topics in the electronic conversation is generated. The list of already discussed topics is filtered from the list of first-user topics to create a suggested topics cue. At least one suggested topic is provided to the second user via a computer display.

### BRIEF DESCRIPTION OF THE DRAWINGS

The present application can be best understood by reference to the following description taken in conjunction with the accompanying figures, in which like parts may be referred to by like numerals.

FIGS. 1 A-C depict an example process for managing cues for conversation engagement, according to some embodiments.

FIG. 2 illustrates an example process of generating a natural language question about a topic of interest to a first user, according to some embodiments.

FIG. 3 illustrates an example algorithm for topic generation, according to some embodiments.

FIG. 4 illustrates an example algorithm for question generation, according to some embodiments.

FIG. 5 is a block diagram of a sample computing environment that can be utilized to implement some embodiments.

FIG. 6 depicts an exemplary computing system that can be configured to perform any one of the processes provided herein.

FIGS. 7-10 depict various use cases of the implementations of processes 100 and 200 and algorithms 300 and 400, according to some embodiments.

FIG. 11 illustrates an example system for generating and managing cues for conversation management, according to some embodiments.

The Figures described above are a representative set, and are not an exhaustive with respect to embodying the invention.

### DESCRIPTION

Disclosed are a system, method, and article of manufacture of managing cues for conversation engagement. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Process Overview

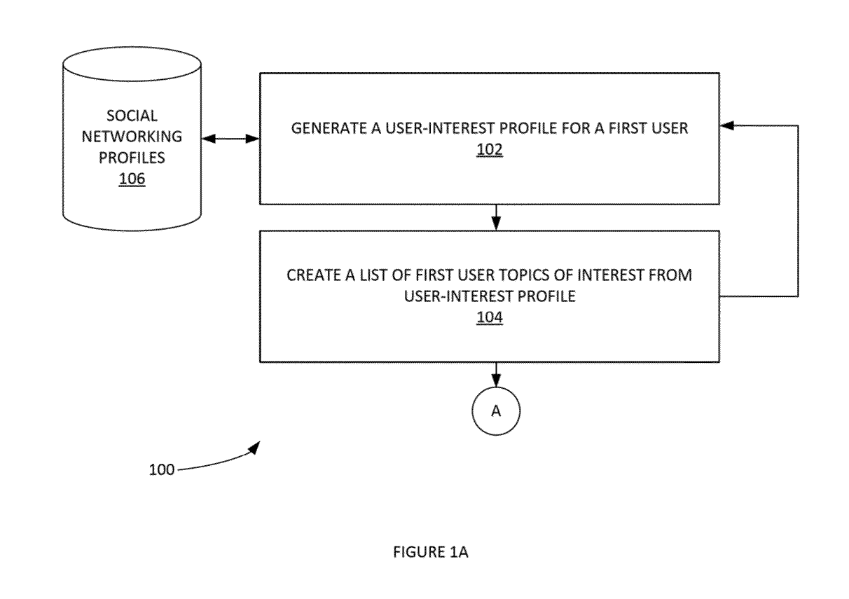

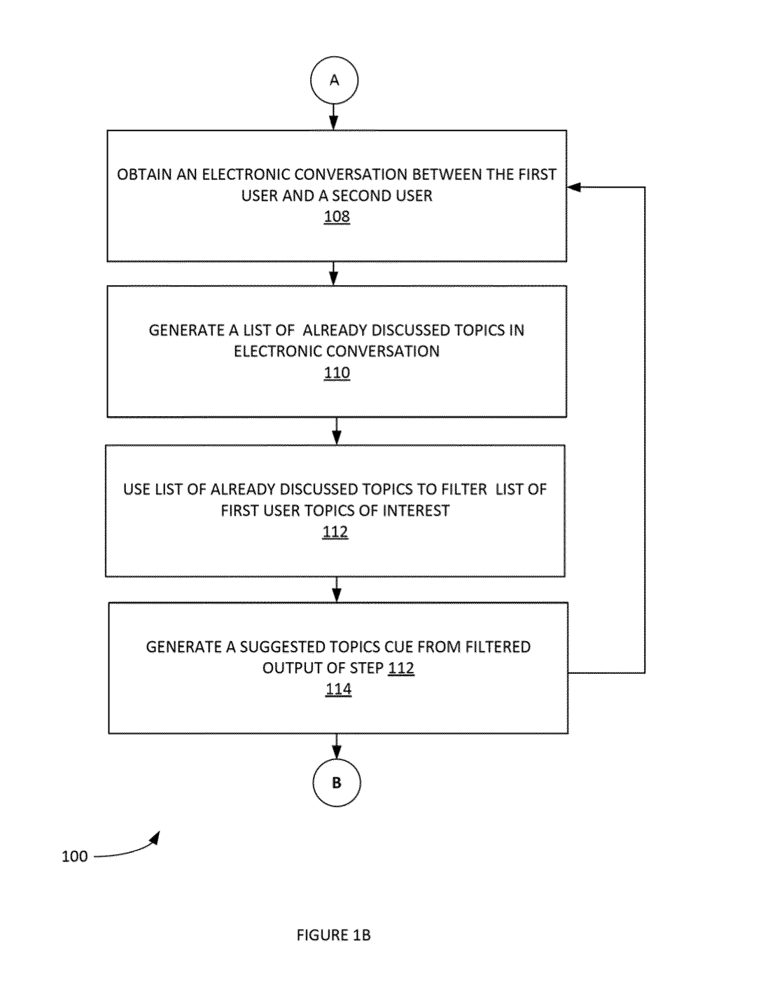

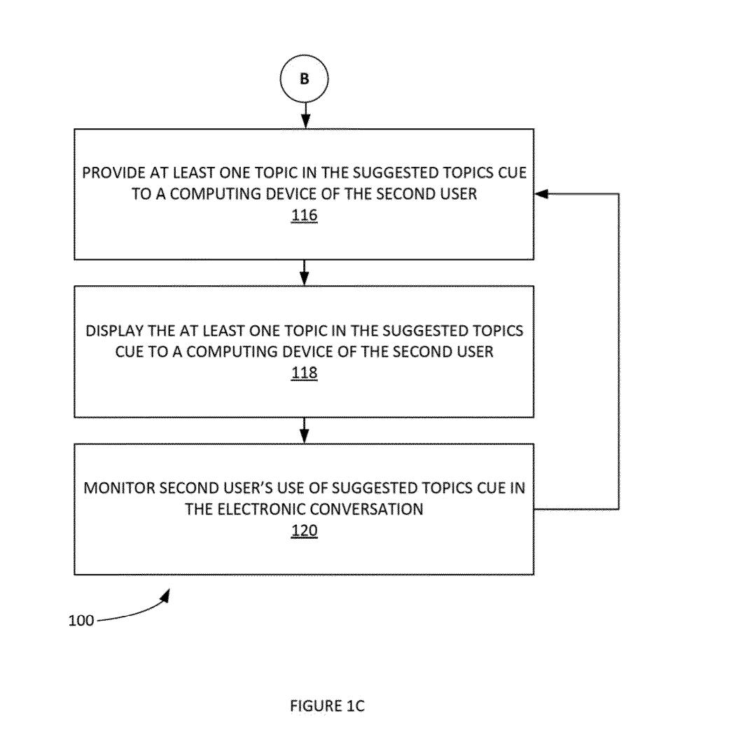

FIGS. 1 A-C depict an example process 100 for managing cues for conversation engagement, according to some embodiments. In step 102 of process 100, a user-interest profile for a first user is generated. In some examples, the user-interest profile can be generated with information from various sources such as a user's social networking profile(s) 106. For example, a user's Facebook® profile can be monitored and information obtained from the user's status updates, ‘likes’, etc. In another example, a user's Twitter® feed can be monitored. Keywords from the user's (e.g. first user, an addressed user, etc.) tweets can be obtained. It is further noted that other social network communication mediums and/or user behavior thereon can be utilized (e.g. Pinterest®, LinkedIn®, Disqus® comments, photo messaging applications, instant messaging and video chat platforms, etc.). Additionally, in some embodiments, the source of information for creating a user-interest profile can be extended to include other data sources such as user input, historical user information relating to past use of cues for conversation engagement, and the like.

A statistical algorithm can be utilized to rank the keywords/topics in the user's social networking profile(s) (and/or other lists created in process 100) based on such factors as frequency of use, recency of use and the like. It is noted that the user's social networking profile(s) may be sampled. There are several methods which may be used to select a proper sample size and/or use a given sample to make statements (within a range of accuracy determined by the sample size) about a specified population. These methods may include, for example:

1. Classical Statistics as, for example, in “Probability and Statistics for Engineers and Scientists” by R. E. Walpole and R. H. Myers, Prentice-Hall 1993; Chapter 8 and Chapter 9, where estimates of the mean and variance of the population are derived.

2. Bayesian Analysis as, for example, in “Bayesian Data Analysis” by A Gelman, I. B. Carlin, H. S. Stern and D. B. Rubin, Chapman and Hall 1995; Chapter 7, where several sampling designs are discussed.

3. Artificial Intelligence techniques, or other such techniques as Expert Systems or Neural Networks as, for example, in “Expert Systems: Principles and Programming” by Giarratano and G. Riley, PWS Publishing 1994; Chapter 4, or “Practical Neural Networks Recipes in C++” by T. Masters, Academic Press 1993; Chapters 15, 16, 19 and 20, where population models are developed from acquired data samples.

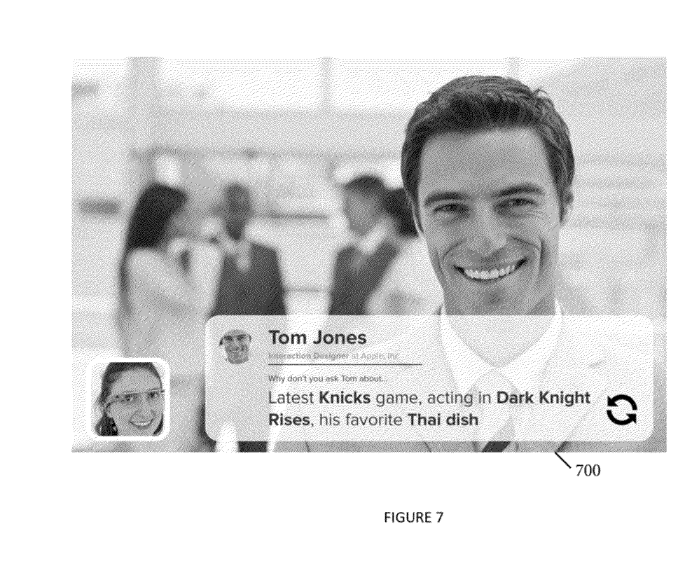

It is noted that these statistical methodologies are for exemplary purposes and other statistical methodologies can be utilized and/or combined in various embodiments. These statistical methodologies can be utilized elsewhere in process 100 when appropriate. Additionally, it is noted that the user-interest profile can include additional information about a user such as his/her current relationship status, demographic information, and the like. This information can also be utilized to augment process 100 and/or process 200 (see examples in FIGS. 7-10 infra).

In step 104, a list of first-user topics of interest are generated from the first user profile. Again, the list of first-user topics of interest can be ranked according to various methodologies and parameters. It is also noted that steps 102 and 104 can be periodically repeated.

In step 106, an electronic conversation (e.g. an email, a text message thread, an instant-messaging thread, a tweet thread, a Facebook message, other social network messaging platform communications, an analog voice conversation that is translated into digital text with a voice-to-text functionality such as one in user-worn computer, an augmented-reality message displayed with a head-mounted display, etc.) can be obtained. For example, the electronic conversation can be between a first user and a second user. In other examples, the electronic conversation can be between a plurality of users and process 100 can be adapted accordingly. A client application in a user's computing device can obtain the electronic conversation and upload it to a server-side environment (e.g. a server implemented in a cloud computing environment). The electronic conversation can be parsed and analyzed. For example, keywords can be sampled from the electronic conversation. Topics of already discussed can be determined. For example, in step 110, a list of already discussed topics in the electronic conversation can be generated.

In step 112, the list of already discussed topics in the electronic conversation can be used to filter the list of first-user topics of interest. For example, the electronic conversation can be a text message thread between the first user and a second user. For example, the two users can have already discussed baseball. Baseball can also be included in the list of first-user topics of interest. The topic ‘baseball’ can then be filtered from the first-user topics of interest for purposes of the present text message thread.

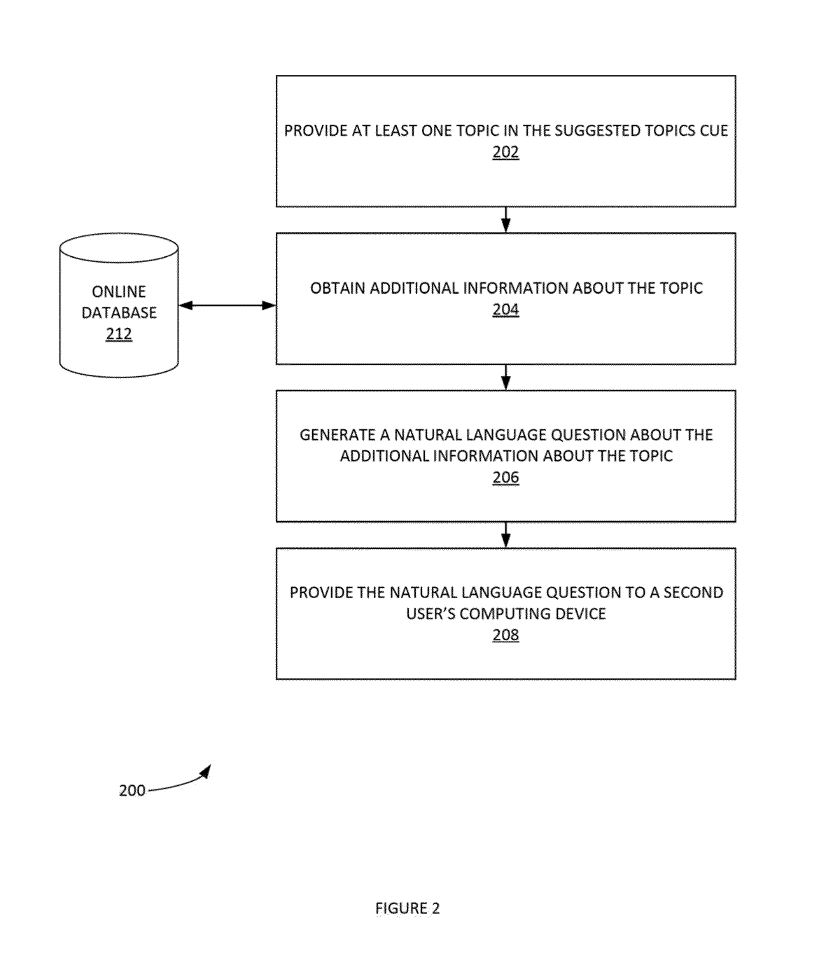

In this way, in step 114, a suggested topic cue is generated from filtered output of step 112. In some embodiments, the suggested topic cue can be further processed to create one or more ‘intelligent questions’ associated with a particular topic. An ‘intelligent question’ can be a natural language question that the second user can ask the first user (e.g. see FIG. 2 infra). The natural language question can include additional information obtained from a data source (e.g. a webpage with information about the topic such as a news webpage, Wikipedia®, online governmental statistics sources, etc.). It is noted that steps 108-114 can be periodically repeated to update a suggested topic cue. Additionally, in some embodiments, feedback from later steps in process 100 (e.g. step 120) can be utilized to manage the content of the suggested topic cue (e.g. remove topics that have been in the cue for a specified period but have not be utilized by the second user in the electronic conversation).

In step 116, at least one topic in the suggested topics cue is provided to a computing device (e.g. a smart phone, a tablet computer, a personal computer, a laptop, a pair of augmented-reality smart glasses such as Google Glass®, etc.). The suggested topics cue can be provided to a client application operating in the computing device.

In step 118, at least one topic in the suggested topics cue can be displayed to the second user (e.g. the user composing a message in the electronic conversation). Examples are provided in FIGS. 7-10 infra. In step 120, the suggested topics in the suggested topics cue can be monitored. For example, if a user introduces the suggested topic into the electronic conversation, then additional information about the suggested topic can be search for on relevant websites and additional questions and/or topics generated and introduced into the topic cue. In another example, if a suggested topic is not utilized within a specific period of time, the suggested topic can be removed from the topics cue. In some example embodiments, steps 116-120 can be repeated on a periodic basis throughout the lifetime of the electronic conversation.

FIG. 2 illustrates an example process 200 of generating a natural language question about a topic of interest to a first user, according to some embodiments. Examples of natural language questions are illustrated in FIGS. 7-10. A natural language question can be derived from various sources such as a user's interest profile, a user's social networking platform(s), user input, conversation topics, etc. Process 200 can be adapted to utilize any of these sources. For example, with respect to deriving a natural language question from a user topic of interest, in step 202, at least one topic in the suggested topics cue is provided. In step 204, additional information about the topic can be obtained. For example, if the topic is the San Francisco Giants baseball team, then additional information about the current news for various San Francisco Giants baseball players can be obtained. Thus, online database 212 can be queried. Examples of online databases 212 can include webpages, governmental statistics databases, social networking platforms, and the like. In step 206, a natural language question about the additional information about the topic can be generated. Various natural language generation algorithms can be utilized. For example, the process of generating natural language (NLG) text question can include keeping a list of ‘canned’ text that is copied and pasted, possibly linked with some glue text. The results may be satisfactory in simple domains. Moreover, a sophisticated NLG system can include stages of planning and merging of information to enable the generation of text that looks natural and does not become repetitive. Typical stages can include, inter alia, the following steps.

Content determination such as deciding what information to mention in the text. For instance, in a baseball example (e.g. baseball being a topic of interest for the first user), deciding whether to explicitly mention a current news topic for a particular baseball team that is also a topic of interest for the first user.

Document structuring methods that take into account the overall organization of the information to convey can be utilized. For example, deciding to describe a particular baseball player's recent news update, instead of the news updates for his baseball team.

Aggregation methods, such merging of similar sentences, can be used to improve readability and naturalness. For instance, merging the two sentences about a first baseball player and a second baseball player for the same team of interest into the single sentence.

Lexical choice methods, such a putting words to the concepts, can be utilized. For example, deciding whether medium or moderate should be used when describing a particular baseball player's recent injury.

Referring expression generation methods, such as creating referring expressions that identify objects and/or regions, can be utilized. For example, deciding to use in particular jargon (e.g. baseball jargon) to refer to a certain objects and/or regions in lieu of more formal words or phrases. This task can also include making decisions about pronouns and other types of anaphora.

Realization methods such as creating the actual text of the natural language question, can be utilized. Realization methods can make corrections according to specified rules of syntax, morphology, and orthography. For example, using ‘will be’ for the future tense of ‘to be’.

In step 208, the natural language question can be provided to a second user's computing device. The natural language question can be displayed to the second user as the second user composes a message to the first user in the applicable electronic conversation (see use cases infra). Processes 100 and 200 can be implemented with a server operating in a cloud platform as a service (PaaS).

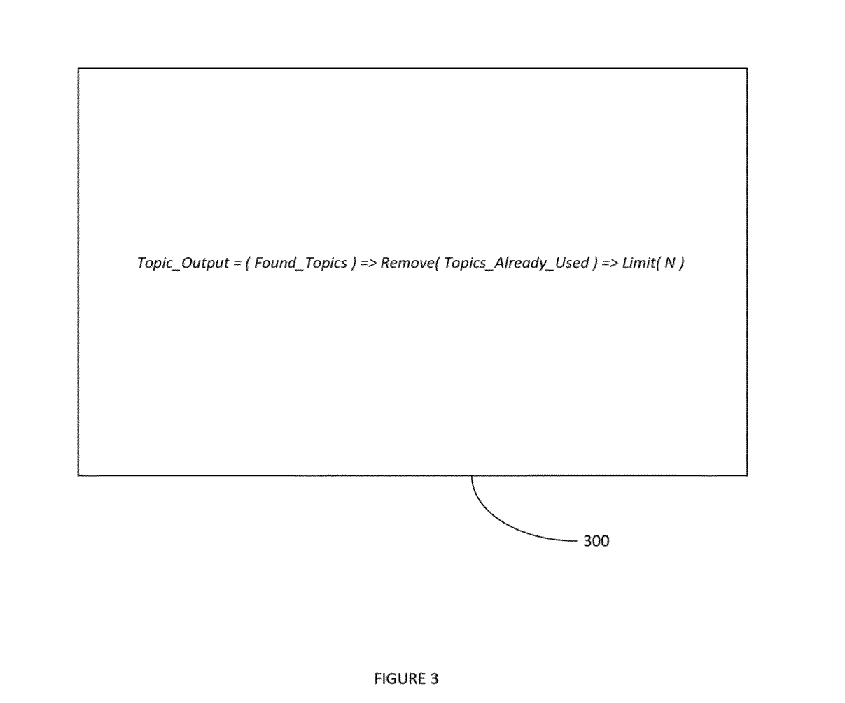

FIG. 3 illustrates an example algorithm 300 for topic generation, according to some embodiments. The ‘Topic_Output’ variable can include list of topics to be provided to a user engaged in an electronic conversation. The ‘(Found_Topics)’ variable (e.g. an array or similar data structure) can include various topics such as those provided in the topics of interest generated from the first user profile of process 100. The ‘(Found_Topics)’ variable can be filtered according to the ‘Remove(Topics_Already_Used)’ function wherein contents of the ‘Topics_Already_Used’ are removed from the ‘(Found_Topics)’ variable. Additionally, the ‘Topic_Output’ variable can be shorted to n-number topics per the ‘Limit(N)’ function.

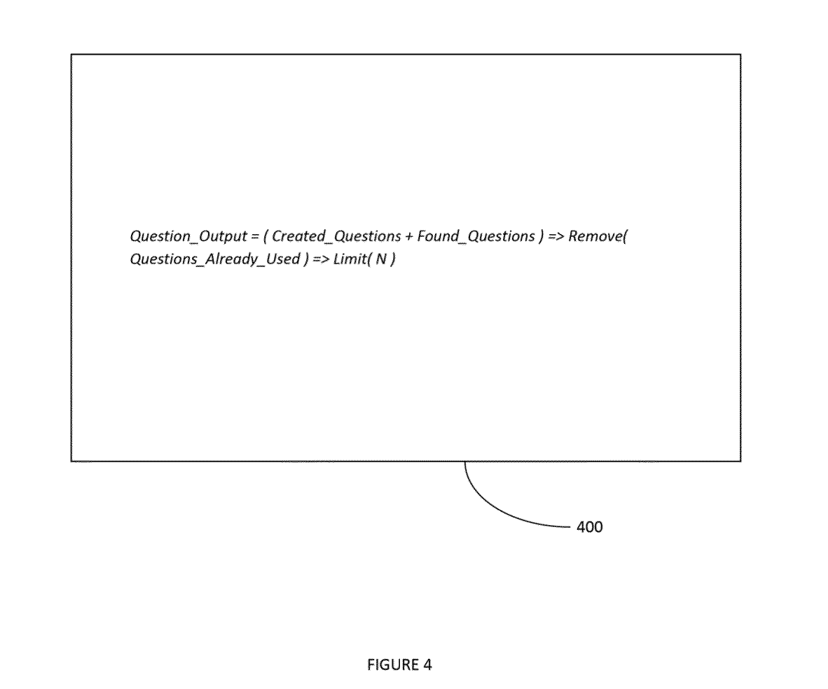

FIG. 4 illustrates an example algorithm 400 for question generation, according to some embodiments. The ‘Question_Output’ variable (e.g. an array, list or similar data structure) can include list of questions to be provided to a user engaged in an electronic conversation. The ‘(Created_Questions+Found_Questions)’ variable an include various questions such as those provided in process 200 and found in various other locations. The ‘(Found_Questions)’ variable can be filtered according to the ‘Remove(Questions_Already_Used)’ function wherein contents of the ‘Questions_Already_Used’ are removed from the ‘Question_Output’ variable. Additionally, the ‘Question_Output’ variable can be shorted to n-number questions per the ‘Limit(N)’ function. Algorithms 300 and 400 can be utilized to implement process 100 and/or process 200 according to various embodiments.

Exemplary Environment and Architecture

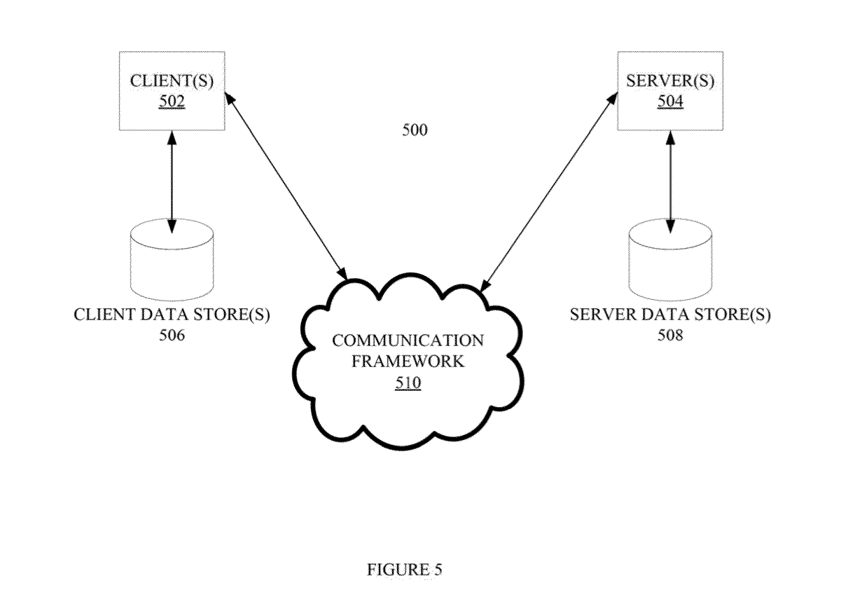

FIG. 5 is a block diagram of a sample computing environment 500 that can be utilized to implement some embodiments. The system 500 further illustrates a system that includes one or more client(s) 502. The client(s) 502 can be hardware and/or software (e.g., threads, processes, computing devices). The system 500 also includes one or more server(s) 504. The server(s) 504 can also be hardware and/or software (e.g., threads, processes, computing devices). One possible communication between a client 502 and a server 504 may be in the form of a data packet adapted to be transmitted between two or more computer processes. The system 500 includes a communication framework 510 that can be employed to facilitate communications between the client(s) 502 and the server(s) 504. The client(s) 502 are connected to one or more client data store(s) 506 that can be employed to store information local to the client(s) 502. Similarly, the server(s) 504 are connected to one or more server data store(s) 508 that can be employed to store information local to the server(s) 504.

In some embodiments, system 500 can be include and/or be utilized by the various systems and/or methods described herein to implement process 100. For example, the specified content of step 102 can be stored in 506 and/or 508. User login verification can be performed by server 504. Client 502 can be in an application (such as a web browser, augmented reality application, text messaging application, email application, instant messaging application, etc.) operating on a computer such as a personal computer, laptop computer, mobile device (e.g. a smart phone, a smart watch, a pair of smart glasses such as Google Glass®, other wearable computers, etc.) and/or a tablet computer. In some embodiments, computing environment 500 can be implemented with the server(s) 504 and/or data store(s) 508 implemented in a cloud computing environment.

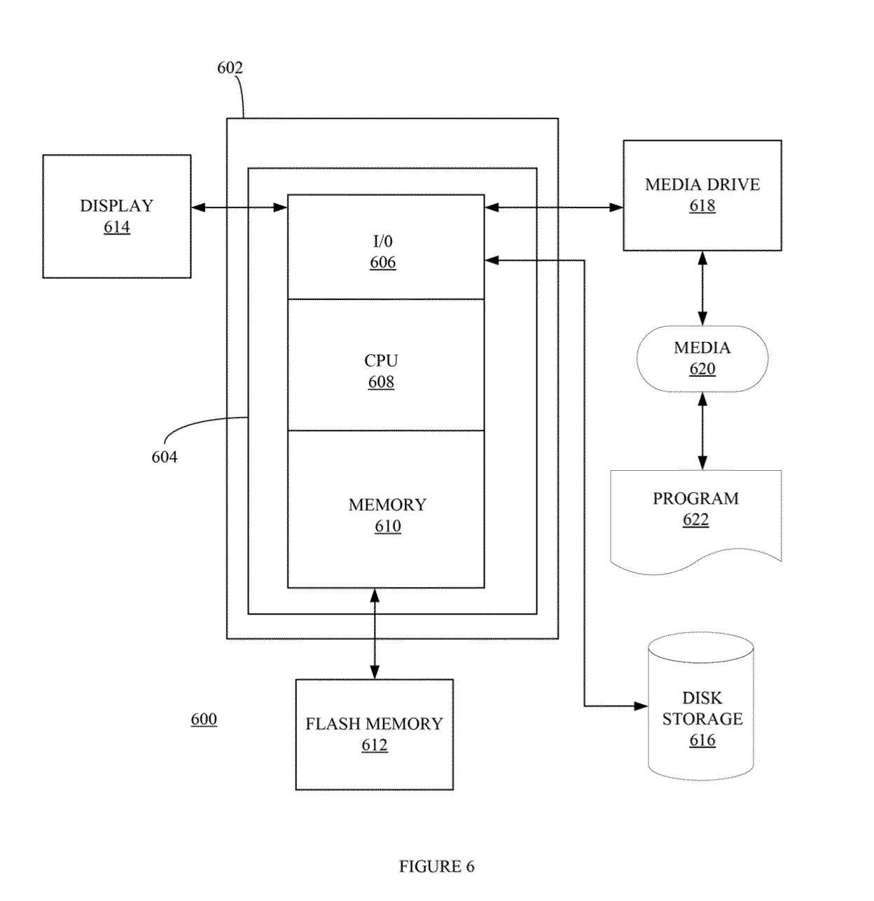

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. In another example, computing system 600 can be configured as a mobile device and include such systems as may be typically included in a mobile device such as GPS systems, gyroscope, accelerometers, cameras, augmented-reality systems, etc.

Exemplary Use Cases

FIGS. 7-10 depict various use cases of the implementations of process 100, process 200, algorithm 300 and/or algorithm 400, according to some embodiments. FIG. 7 depicts an example 700 of an augmented-reality message displayed with an augmented-reality wearable computer with a head-mounted display (HMD) (e.g. Google Glass®). For example, the smart glasses can include an image recognition module that identifies ‘Tom Jones’ from images obtained by an outward facing camera. Process 100 can then be utilized to generate and rank a suggested topic cue. The top three topics can then be displayed by the HMD (e.g. as augmented-reality elements). Eye-tracking algorithms can also be utilized to determine which of the topics is of greatest interest to the user wearing the HMD (e.g. according to user eye-fixation periods). A microphone in the HMD system can monitor the conversation and feed the information to a module that determines which topics have already been discussed. Voice-to-text applications can be utilized to analyze the content of a spoken conversation.

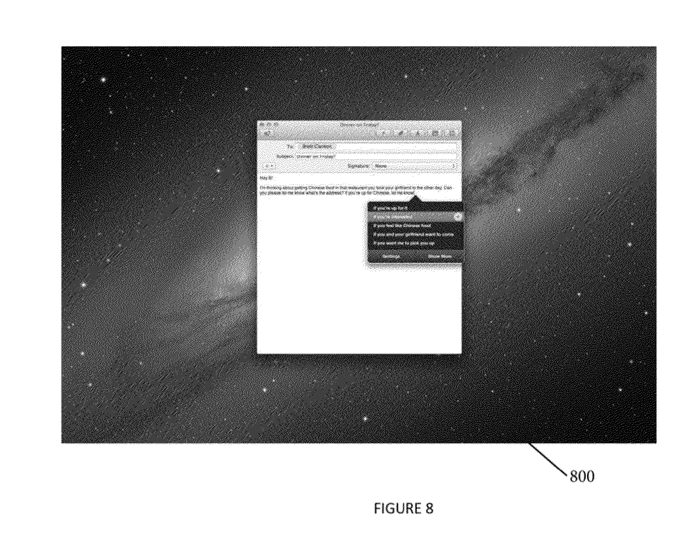

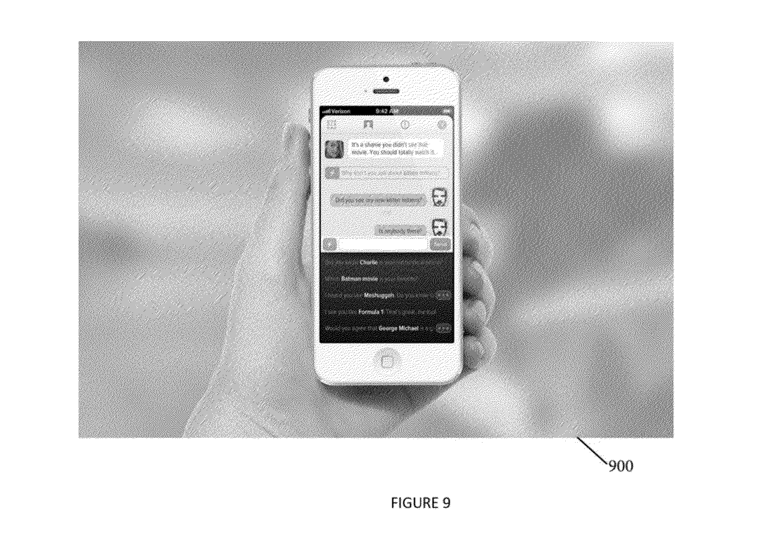

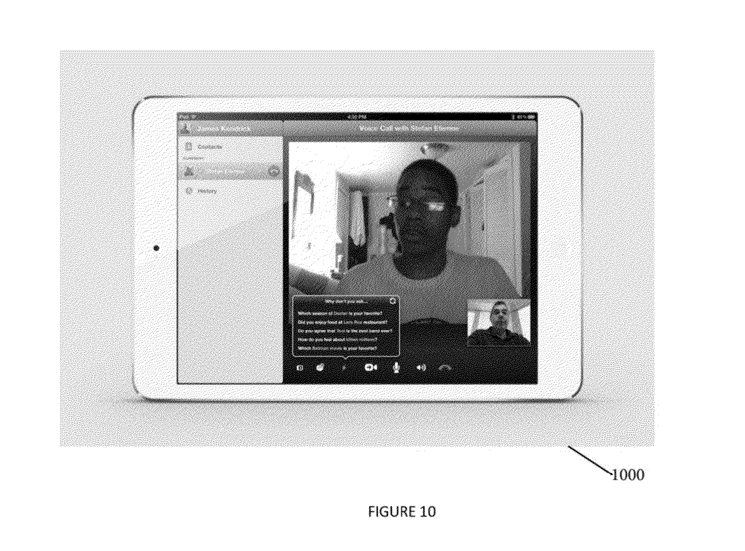

FIG. 8 depicts an implementation of a process 800 for manufacture of managing cues for conversation engagement in an email context. FIG. 9 depicts an implementation of a process 900 for manufacture of managing cues for conversation engagement in a text messaging thread context. FIG. 10 depicts an implementation of a process 1000 for manufacture of managing cues for conversation engagement in a voice over IP (VOIP) context. These use cases are provided by way of example and not of limitation.

Additional Exemplary Environment and Architecture

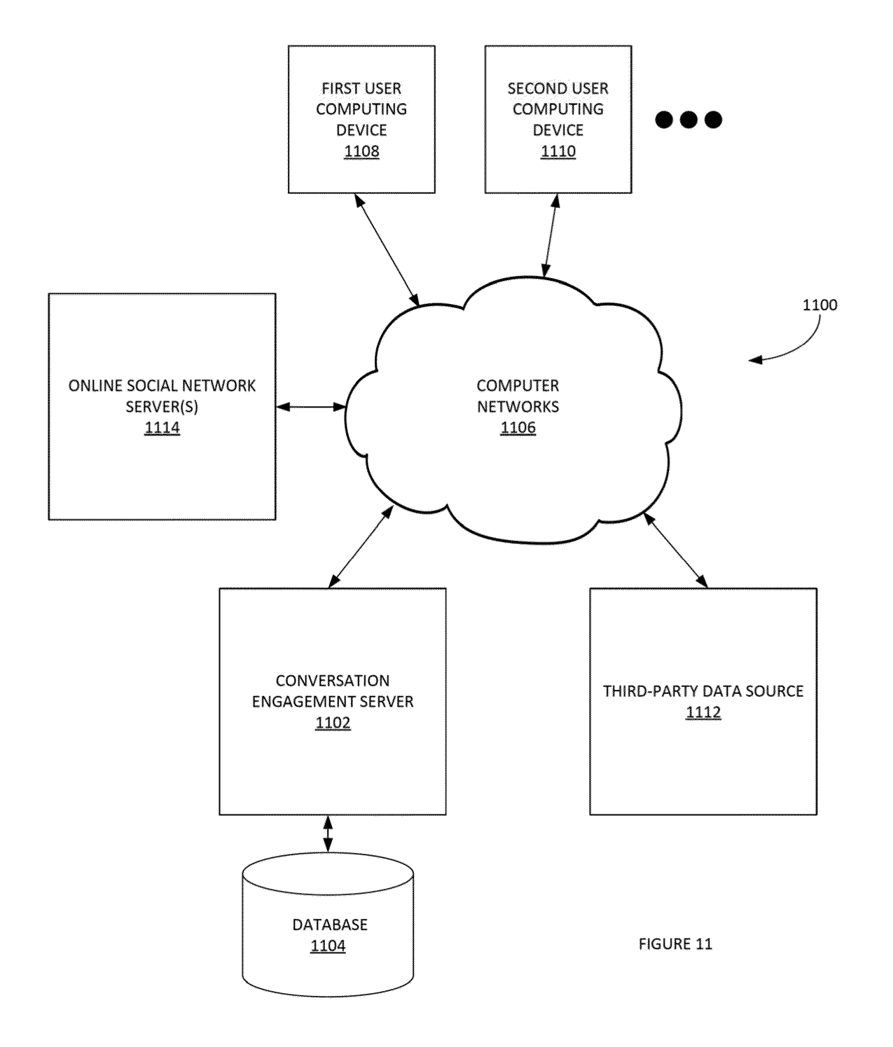

FIG. 11 illustrates an example system 1100 for generating and managing cues for conversation management, according to some embodiments. System 1100 can include conversation engagement server 1102. Conversation engagement server 1102 can include various functionalities for performing specified processes included herein such as processes 100, 200, algorithm 300, algorithm 400 and/or processes associated with FIGS. 7-10, for example. Conversation engagement server 1102 can web server, database management and/or search engine functionalities. Conversation engagement server 1102 can extract a user's social networking information from online social network server(s) 1114. Conversation engagement server 1102 can extract additional data from third-party data sources 1112. Conversation engagement server 1102 can voice-to-text and/or text-to-voice functionalities. Conversation engagement server 1102 can include natural language processes and/or generation functionalities. For example, conversation engagement server 1102 can use natural language processing algorithms based on machine learning methods, such as statistical machine learning methods. Conversation engagement server 1102 can include various natural language processing functionalities, such as, inter alia: automatic summarization, co-reference resolution, discourse analysis, machine translation, morphological segmentation, named entity recognition, natural language generation, natural language understanding, optical character recognition, part-of-speech tagging, parsing, question answering, relationship extraction, sentence breaking, sentiment analysis, speech recognition, speech segmentation, topic segmentation and recognition, word segmentation, word sense disambiguation, information retrieval, information extraction, and/or speech processing. Conversation engagement server 1102 can user interest data and/or associated metadata in database 1104. Conversation engagement server 1102 can score a list of user interests (e.g. based on such factors as a user state, user location, topic of a conversation, one or more topics of historical conversations between two or more users, and/or any combination thereof). Conversation engagement server 1102 can generate conversation topic cues in a natural language format and provide said cues to a client application in a user device. Conversation engagement server 1102 can extract information from various user conversation functionalities (e.g. emails, text messages, augmented reality messages, etc.) from user computing devices 1108 and/or 1110. Conversation engagement server 1102 can extract user state and/or location information from user computing devices 1108 and/or 1110 and/or other user devices (e.g. wearable computers, environmental sensors, etc.). Conversation engagement server 1102 can determine a substantially current (e.g. assuming system networking and/or processing latencies) conversation topic. For example, conversation engagement server 1102 can determine a current conversation topic based on methods provided supra and/or factors such a key word frequency, key word meaning, image recognition functionalities, a location of a user, user computing device state, other factors provided herein, and/or any combination thereof. In some embodiments, conversation engagement server 1102 can implement an instant messaging and video chat platform. In other example embodiments, conversation engagement server 1102 can interact with an instant messaging and video chat platform (e.g. obtain user communications and/or provide real-time, dynamic conversation cues to users of said platforms).

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of managing cues for conversation management comprising:
generating, with at least one processor, a first user-interest profile;
creating a list of first-user topics from the first user-interest profile;
obtaining an electronic conversation between the first user and a second user;
generating a list of already discussed topics in the electronic conversation;
filtering the list of already discussed topics from the list of first-user topics to create a suggested topics cue; and
providing at least one suggested topic to the second user via a computer display.

2. The method of claim 1, wherein the first user profile is generated from a first user's online social networking profile.

3. The method of claim 2, further comprising:
extracting one or more keywords from one or more status updates provided by the first user to the first user's online social networking profile.

4. The method of claim 3, wherein the electronic conversation comprises at least one of an email, a text message, an instant message or an augmented-reality message.

5. The method of claim 4, further comprising:
translating the at least one suggested topic into an intelligent question, wherein the intelligent question comprises a natural language question requesting additional information about the at least one suggested topic.

6. The method of claim 5, further comprising:
including additional information obtained from an Internet encyclopedia in the natural language question.

7. The method of claim 1, further comprising:
determining when the second user uses the at least one suggested topic.

8. The method of claim 7, wherein the at least one suggested topic is removed from the suggested topics cue when it is determined that the second user has not used the at least one suggested topic within a specified period of time.

9. A computerized system comprising:
a processor configured to execute instructions;
a memory containing instructions when executed on the processor, causes the processor to perform operations that:
generate, with at least one processor, a first user-interest profile;
create a list of first-user topics from the first user-interest profile;
obtain an electronic conversation between the first user and a second user;
generate a list of already discussed topics in the electronic conversation;
filter the list of already discussed topics from the list of first-user topics to create a suggested topics cue; and
provide at least one suggested topic to the second user via a computer display.

10. The computerized system of claim 9, wherein the memory containing instructions when executed on the processor, further causes the processor to perform operations that:
determine when the second user uses the at least one suggested topic.

11. The computerized system of claim 10, wherein the at least one suggested topic is removed from the suggested topics cue when it is determined that the second user has not used the at least one suggested topic within a specified period of time.

12. The computerized system of claim 9, wherein the first user profile is generated from a first user's online microblogging service.

13. The computerized system of claim 12, wherein the memory containing instructions when executed on the processor, further causes the processor to perform operations that:
extract one or more keywords from one or more microblog posts provided by the first user to the first user's online microblogging service.

14. The computerized system of claim 13, wherein the memory containing instructions when executed on the processor, further causes the processor to perform operations that:
translate the at least one suggested topic into an intelligent question, wherein the intelligent question comprises a natural language question requesting additional information about the at least one suggested topic.

15. The computerized system of claim 14, wherein the memory containing instructions when executed on the processor, further causes the processor to perform operations that:
include additional information obtained from an Internet encyclopedia in the natural language question.

16. The computerized system of claim 15, wherein the memory containing instructions when executed on the processor, further causes the processor to perform operations that:
determine when the second user uses the at least one suggested topic.

17. The computerized system of claim 16, wherein the at least one suggested topic is removed from the suggested topics cue when it is determined that the second user has not used the at least one suggested topic within a specified period of time.
